(19) United States
(12) Patent Application Publication
(10) Pub. No.: US 2026/0313734 A1
(43) Pub. Date: Oct. 8, 2026

(54) Storing N26 Interworking and Other Contextual Information in a User Equipment

(71) Applicant: Apple Inc., Cupertino, CA (US)

(72) Inventors: Vivek G Gupta, San Jose, CA (US); Sridhar Prakasam, Fremont, CA (US); Nirlesh Koshta, Bangalore (IN)

(21) Appl. No.: 19/482,519

(22) PCT Filed: May 9, 2024
(86) PCT No.: PCT/US2024/028559

§ 371 Date: Nov. 7, 2025

(30) Foreign Application Priority Data
May 12, 2023 (IN) 202311033503

(51) Int. Cl. H04W 76/19

(52) U.S. Cl. CPC H04W 76/19

(57) ABSTRACT

Methods, systems, and devices for storing information in a User Equipment (UE) are described. The methods include storing an N26 indicator in non-volatile memory (NVM) and/or a USIM of the UE. If a connection that supports an N26 interface is lost, the stored indicator may be used to facilitate reconnection. The methods also include storing operator controlled signal thresholds for selecting a Public Land Mobile Network (PLMN).

### FIELD

The present application relates to wireless devices and wireless networks, including systems, devices, circuits, and methods for storing N26 interworking and other contextual information in a User Equipment (UE) for Wireless Communication.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

In 5G Systems (5GS), some parts of the 5G Mobility Management (5GMM) information are stored in non-volatile memory (NVM) or a Universal Subscriber Identity Module (USIM) of the UE. The storage of this information in the UE is necessary for the proper operation of the UE in different scenarios.

However, the storage available on a UE is not infinite. Accordingly, there is a need to balance the necessary information for efficient network behavior with the storage and accessibility of data on a UE.

### SUMMARY

In one aspect, embodiments relate to a method for inter-system mobility (mobility across 5GS and EPS and vice versa) that includes receiving an N26 indicator when connecting to a first network, and storing the N26 indicator. If the connection is to the first network after storing the N26 indicator, the method includes connecting to a second network using the N26 indicator. The first and second networks may be a 5GS and an Evolved Packet System (EPS).

In another aspect, embodiments relate to a method for Public Land Mobile Network (PLMN) selection that includes connecting to a Home-PLMN (HPLMN) and storing thresholds for accessing the HPLMN and one or more visiting-PLMNs (VPLMNs). The method also includes comparing a signal level of PLMNs in a Tracking Area (TA) to the thresholds and selecting a VPLMN based on the comparison.

The techniques described herein may be implemented in and/or used with a number of different types of devices, including but not limited to cellular phones, wireless devices, tablet computers, wearable computing devices, portable media players, Internet of Things (IoT) devices, vehicles, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates a communication device, according to some aspects.

FIG. 3 illustrates an example block diagram of a Base Station (BS), according to some aspects.

FIG. 4 illustrates the interworking between 5GS and EPS, according to some aspects.

FIG. 5 illustrates a method for mobility across networks, according to some aspects.

FIG. 6 illustrates organization aspects for storing N26 information, according to some aspects.

FIG. 7 demonstrates a method for PLMN selection using the stored thresholds, according to some aspects.

FIG. 8 illustrates an organization for storing thresholds, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

In general, embodiments disclosed herein are directed to storing interworking information in non-volatile memory (NVM) to facilitate wireless network operations. The storage of this information in the UE helps the proper operation of the UE in several scenarios such as interworking across 5GS and an Evolved Packet System (EPS), during inter-system change, during power resets when migrating from 5GS to EPS communication and vice versa. Storage of such information aides with using several 5GS features such as network slicing, disaster roaming, Public Land Mobile Network (PLMN) selection, handovers, etc.

Currently, standard protocols govern the storage of information of 5GMM information that is stored on USIM of a UE. This includes parameters such as the 5G-Global Unique Temporary Identifier (5G-GUTI), the last visited registered Tracking Area Identity (TAI), the 5GS update status, the 5G Non-Access Stratum (NAS) security context parameters from a full native 5G NAS security context, etc. Standard protocols also govern parameters that are stored in a NVM in the Mobile Equipment (ME) together with the Subscription Unique Temporary Identifier (SUPI) from the USIM such as the configured Network Slice Selection Assistance Information (NSSAIs), Network Slice Simultaneous Registration Group (NSSRG) information, NSSAI inclusion modes, one or more lists of type “list of PLMN(s) to be used in disaster condition,” if the UE supports minimization of service interruption (MINT), etc.

However, standard protocols do include storing an indication of whether interworking without a N26 interface is supported or not. As a result, inter-system mobility between 5GS and EPS may use an incorrect UE identity, and UE may be denied service.

For example, if a UE is registered on NR (5GS) and the UE is operating in a Public Land Mobility Network (PLMN) that provides interworking between 5GS and EPS based on an N26 interface, as part of registration, the UE receives an indication of “EPS-5G IWK with N26 interface” in a REGISTRATION ACCEPT message. If the UE is powered off while in the 5GS, the UE stores the 5G-GUTI, 5G NAS security context parameters, etc. in the USIM, as well as other parameters in NVM, but the UE currently does not store an indication of “EPS-5G IWK with N26 interface” parameter. If the UE is powered on and camps on a Long Term Evolution (LTE) Radio Access Technology (RAT) (connected to EPS) of the same PLMN on which NR registration was active before the UE was power off, the UE will determine the mobile identity, (Globally Unique Mobily Management Entity (MME) Identifier) GUMMEI, and security context to be used in the Attach Request based on the last registered RAT.

Because the UE has not stored an indication of “EPS-5G IWK with N26 interface” received in the previous REGISTRATION ACCEPT message in NVM or the USIM, when UE powers on, the UE will use the mobile identity as the international mobile subscriber identity (IMSI) (associated with LTE) rather than deriving the UE identity from the 5G-GUTI. As such, the UE incorrectly determines the UE identity sent to the network in the attach procedure (in the ATTACH REQUEST). Further, the UE will incorrectly derive the GUMMEI identity from a 4G-GUTI instead of the 5G-GUTI, and the UE will not integrity protect the ATTACH REQUEST message in LTE using the 5GS security context. It is further unclear what parameters the UE will use when completing the “5GMM registration status.”

The challenges presented in the above example are also present when a UE is attached to EPS and powers on in 5GS (i.e., vise-versa to the above example).

Embodiments disclosed herein overcome the above deficiencies by storing an indication of “EPS-5G IWK with N26 interface” as a 5GMM parameter in NVM in the ME and with the SUPI from the USIM. As such, in accordance with embodiments, during an initial registration accepted by the network, the UE shall store the received interworking without N26 interface indicator for inter-system change with EPS and treat the indicator as valid in the entire PLMN and its equivalent [ok]PLMN(s). Further, in accordance with embodiments, during a mobility and periodic registration update accepted by the network, the UE stores the received interworking without N26 interface indicator for inter-system change with EPS as specified and treats the indicator as valid in the entire PLMN and its equivalent PLMN(s).

Interworking with EPS using the N26 interface is a main deployment scenario for most operators. Embodiments disclosed herein have the advantage of storing information for the proper operation of UE in several scenarios such as interworking across 5GS and EPS, during inter-system change, during power resets when migrating from 5GS to EPS and vice versa.

In addition to the above, in accordance with some embodiments, as part of Signal Level Enhanced Network Selection (SENSE) development, a UE may take the signal levels of available cells into account during the initial steps of network/PLMN selection, after switch-on or recovery from loss of coverage, and during all steps of the periodic re-selection. That is, embodiments of a UE may store measurement thresholds and a list of available Single—Network Slice Selection Assistance Information (S-NSSAI) slices with available PLMNs in prioritized order. The signal thresholds may be stored in the UE using a Steering of Roaming (SoR) mechanism, and the thresholds may be stored in the NVM of the UE. The storage of such thresholds may have a significant impact on stationary Internet of Things (IoT) devices.

When deployed outdoors, stationary IoT devices may have difficulty being reached in remote locations. In some conditions, the local coverage conditions can be very challenging. IoT devices may also be in a permanent roaming situation. This may be due to the modules of the IoT devices being deployed in different countries than that of the provided USIM, or because of the use of Global USIMs for IoT devices.

These IoT UEs may experience unstable conditions. For example, during network selection procedure (i.e., a PLMN selection) a UE may select a PLMN and stay on that PLMN, where the IoT device can barely attach. Because of changing radio conditions (e.g., fading, absorption etc.), a data bearer may fail to be established too often. Further, for reattachment, as a default, a UE may simply look for the last registered PLMN, without even considering other VPLMNs that may be more accommodating. Currently, it is not possible for the operators of the PLMNs to detect such problems. If such a case occurs, manual intervention at the site of the IoT device may be needed to identify and fix the problem. These issues may impact operating expenditures (OPEX), and the manual interventions may greatly impact deployments.

As noted above, a UE may select a PLMN and stay on that PLMN, where the IoT device can barely attach. This is due to the current network selection procedure which impacts how HPLMNs/VPLMNs are selected when roaming. During the initial steps of selecting a network (e.g., after switching power on or recovery, from the loss of coverage, and during all steps of periodic re-selection), the signal level of the available cells is not taken into account. Only the cell selection criteria as broadcasted by the PLMN and the priority of networks is considered. Thus, the UE may select or stay on a network with poor coverage at that particular location because the selected PLMN has higher priority, albeit poor coverage, while other PLMNs of lower priority are available with much better local coverage.

For typical consumer UEs, the poor connection may go unnoticed because of quickly changing conditions due to mobility. In some cases, a user may recognize a problem and react by changing location a bit, or by using manual PLMN selection. Further, it is noted that steering of roaming is designed to avoid frequent changes of networks. Accordingly, for stationary IoT devices (without supervision by a user), the above scenario may cause significant problems.

Embodiments disclosed herein take the signal level of available cells into account during the initial steps of network selection (e.g., after switch-on or recovery, from loss of coverage, and during all steps of the periodic re-selection). This is achieved by storing “Operator controlled signal threshold per access technology,” if the UE supports SENSE in accordance with embodiments. The “Operator controlled signal threshold per access technology” data is stored as a 5GMM parameter in NVM in the ME together with the SUPI from the USIM. In embodiments, the “Operator controlled signal threshold per access technology” may only be used if the SUPI from the USIM matches the SUPI stored in the non-volatile memory of the ME. If the SUPI from the USIM does not match the SUPI stored in the non-volatile memory, the UE may delete the “Operator controlled signal threshold per access technology” stored in the UE.

The following is a glossary of additional terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.” User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™ Nintendo DS™, PlayStation Vita™, Play Station Portable™, Gameboy Advance™ iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” or “mobile station (MS)” or mobile equipment (ME) may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e. g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

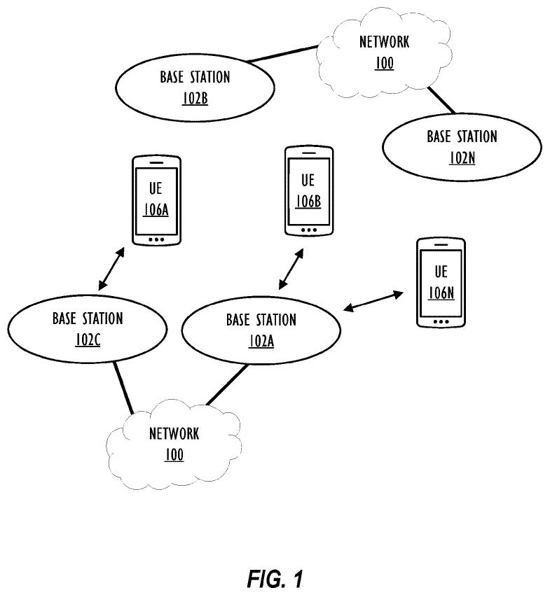

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP 2CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a side link (SL) interface for direct communications between devices. The IoT UEs may also execute background applications (e.g., keep-alive messages, status updates, and the like) to facilitate the connections of the IoT network.

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (VUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high-speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more TRPs. In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device. Embodiments may also include vehicles, industrial equipment, or other devices that may benefit from multi-panel wireless connectivity.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a BB processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

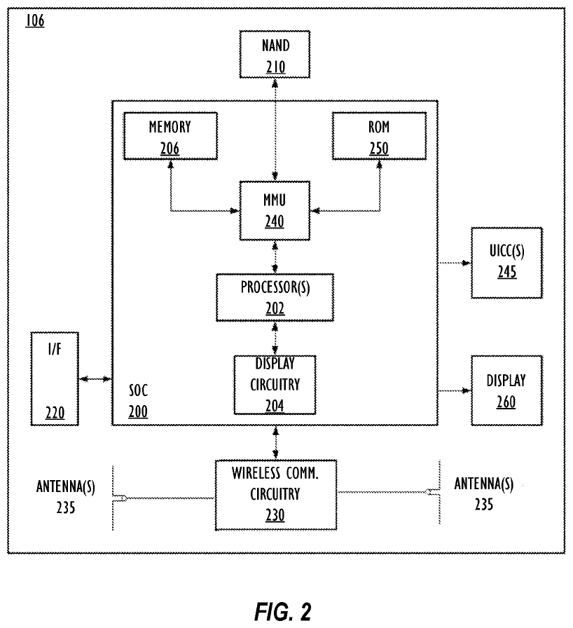

FIG. 2 illustrates an example simplified block diagram of a communication device 106, according to some aspects. It is noted that the block diagram of the communication device of FIG. 2 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 200 configured to perform core functions. For example, this set of components may be implemented as a system on chip (SOC), which may include portions for various purposes. Alternatively, this set of components 200 may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 210), an input/output interface such as connector I/F 220 (e.g., for connecting to a computer system; dock; charging station; input devices, such as a microphone, camera, keyboard; output devices, such as speakers: and the like), the display 260, which may be integrated with or external to the communication device 106, and wireless communication circuitry 230 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 230 may couple (e.g., communicatively; directly or indirectly) to one or more antennas, such as antenna(s) 235 as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 230 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 230 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements. The communication device 106 may further include one or more smart cards 245 that include Subscriber Identity Module (SIM) functionality, such as one or more Universal Integrated Circuit Card(s) (UICC(s)) cards 245.

As shown, the SOC 200 may include processor(s) 202, which may execute program instructions for the communication device 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e. g., memory 206, read only memory (ROM) 250, NAND flash memory 210) and/or to other circuits or devices, such as the display circuitry 204, wireless communication circuitry 230, connector I/F 220, and/or display 260. The MMU 240 may be configured to perform memory protection and page table translation or set up. In some aspects, the MMU 240 may be included as a portion of the processor(s) 202.

As noted above, the communication device 106 may be configured to communicate using wireless and/or wired communication circuitry. As described herein, the communication device 106 may include hardware and software components for implementing any of the various features and techniques described herein. The processor 202 of the communication device 106 may be configured to implement part or all of the features described herein (e.g., by executing program instructions stored on a memory medium). Alternatively (or in addition), processor 202 may be configured as a programmable hardware element, such as a Field Programmable Gate Array (FPGA), or as an Application Specific Integrated Circuit (ASIC). Alternatively (or in addition) the processor 202 of the communication device 106, in conjunction with one or more of the other components 200, 204, 206, 210, 220, 230, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, and the like) configured to perform the functions of processor(s) 202.

Further, as described herein, wireless communication circuitry 230 may include one or more processing elements. In other words, one or more processing elements may be included in wireless communication circuitry 230. Thus, wireless communication circuitry 230 may include one or more integrated circuits (ICs) that are configured to perform the functions of wireless communication circuitry 230. In addition, each integrated circuit may include circuitry (e.g., first circuitry, second circuitry, and the like) configured to perform the functions of wireless communication circuitry 230.

### Example Base Station

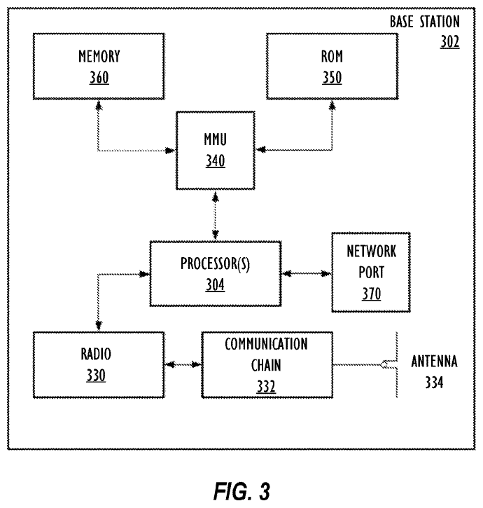

FIG. 3 illustrates an example block diagram of a base station 302, according to some aspects. It is noted that the base station of FIG. 3 is a non-limiting example of a possible base station. As shown, the base station 302 may include processor(s) 304 which may execute program instructions for the base station 302. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 302 may include at least one network port 370. The network port 370 may be configured to couple to a telephone network and provide a plurality of devices, such as UE devices 106, access to the telephone network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

In some aspects, base station 302 may be a next generation base station, (e.g., a 5G New Radio (5G NR) base station, or “gNB”). In such aspects, base station 302 may be connected to a legacy evolved packet core (EPC) network and/or to a NR core (NRC)/5G core (5GC) network. In addition, base station 302 may be considered a 5G NR cell and may include one or more transition and reception points (TRPs). In addition, a UE capable of operating according to 5G NR may be connected to one or more TRPs within one or more gNBs.

The base station 302 may include at least one antenna 334, and possibly multiple antennas. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless communication standards, including 5G NR, LTE, LTE-A, GSM, UMTS, CDMA2000, Wi-Fi, and the like.

The base station 302 may be configured to communicate wirelessly using multiple wireless communication standards. In some instances, the base station 302 may include multiple radios, which may enable the base station 302 to communicate according to multiple wireless communication technologies. For example, as one possibility, the base station 302 may include an LTE radio for performing communication according to LTE as well as a 5G NR radio for performing communication according to 5G NR. In such a case, the base station 302 may be capable of operating as both an LTE base station and a 5G NR base station. When the base station 302 supports mmWave, the 5G NR radio may be coupled to one or more mmWave antenna arrays or panels. As another possibility, the base station 302 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 302 may include hardware and software components for implementing or supporting implementation of features described herein. The processor 304 of the base station 302 may be configured to implement or support implementation of part or all of the methods described herein (e.g., by executing program instructions stored on a memory medium). Alternatively, the processor 304 may be configured as a programmable hardware element, such as a Field Programmable Gate Array (FPGA), or as an Application Specific Integrated Circuit (ASIC), or a combination thereof. Alternatively (or in addition) the processor 304 of the BS 302, in conjunction with one or more of the other components 330, 332, 334, 340, 350, 360, 370 may be configured to implement or support implementation of part or all of the features described herein.

In addition, as described herein, processor(s) 304 may include one or more processing elements. Thus, processor(s) 304 may include one or more integrated circuits (ICs) that are configured to perform the functions of processor(s) 304. In addition, each integrated circuit may include circuitry (e.g., first circuitry, second circuitry, and the like) configured to perform the functions of processor(s) 304.

Further, as described herein, radio 330 may include one or more processing elements. Thus, radio 330 may include one or more integrated circuits (ICs) that are configured to perform the functions of radio 330. In addition, each integrated circuit may include circuitry (e.g., first circuitry, second circuitry, and the like) configured to perform the functions of radio 330.

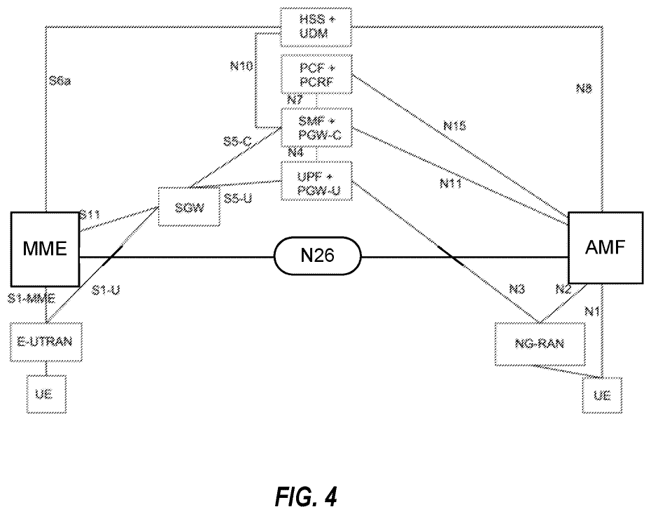

FIG. 4 illustrates the interworking between 5GS and EPC/U-UTRAN systems, according to some aspects. As shown in FIG. 4, the N26 interface between the MME and 5GS Access & Mobility Management Function (AMF) enables interworking between EPC and the NG core and the exchange of Mobility Management (MM) and Session Management (SM) states between the source and target RAT networks.

The N26 interface provides seamless mobility between EPS and 5GS. For example, if a voice call is initiated in NR (i.e., a Voice over NR (VoNR) call), the call can be continued when there is an inter-system mobility to LTE, and the voice call is continued as a Voice over LTE (VOLTE) call.

More specifically, for example, when a UE has multiple PDUs in an LTE Connected state and the network decides to perform Mobility to 5GS when N26 interface is supported, the MME selects the Packet Network Data Gateway (PGW) and Secession Management Function (SMF) for Public Data Network (PDN) Connections that can be relocated to the target 5GS. If the network supports the N26 interface and the UE has indicated for Support of SI and NI mode, then the network configures the UE to receive Quality of Service (QoS) rule(s) of the 5GS QoS flow(s), which corresponds to the dedicated/default EPS bearer being activated.

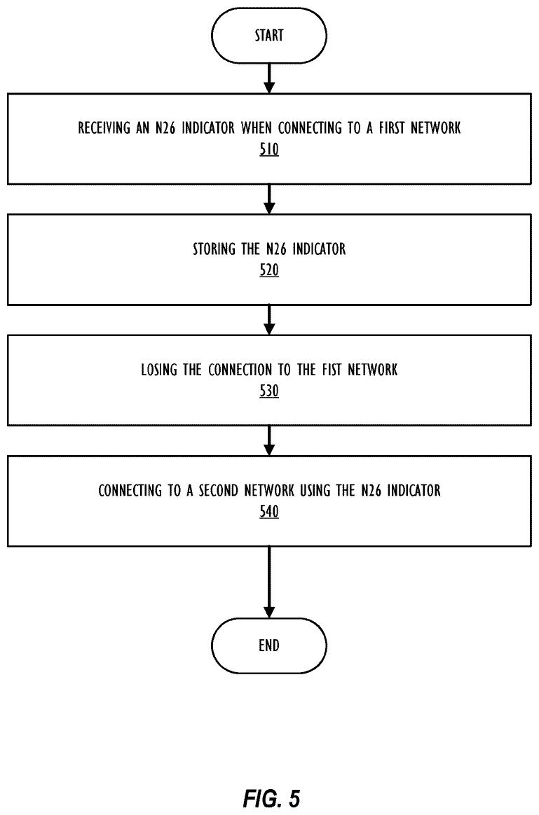

FIG. 5 illustrates a method for mobility across networks, according to some aspects. FIG. 5 describes a general method for mobility across systems in accordance with some embodiments disclosed herein. In Step 510, a UE connects to a first network. During the connection process, an N26 indicator is received.

For example, in the case that the first network is an EPS, the UE may indicate support for NI mode in the ATTACH REQUEST message. Because the MME supports inter-system interworking with 5GS, the MME may set the IWK N26 indicator “interworking without N26 not supported” if the MME does not support interworking procedures without N26 interface or “interworking without N26 supported” if the MME supports interworking procedures without N26 interface. The EPS network feature support Information Element (IE) is set accordingly, and the UE receives the indicator in the ATTACH ACCEPT message transmitted to the UE.

In the case that the first network in a 5GS, the UE may include an S1 mode supported indication in the REGISTRATION REQUEST message transmitted to the network. The AMF supporting interworking with EPS shall set the IWK N26 indicator to either “interworking without N26 interface not supported” if the AMF supports N26 interface or “interworking without N26 interface supported” if the AMF does not support the N26 interface. An IE is set in the 5GS network feature support, and the UE receives the IE in the REGISTRATION ACCEPT message.

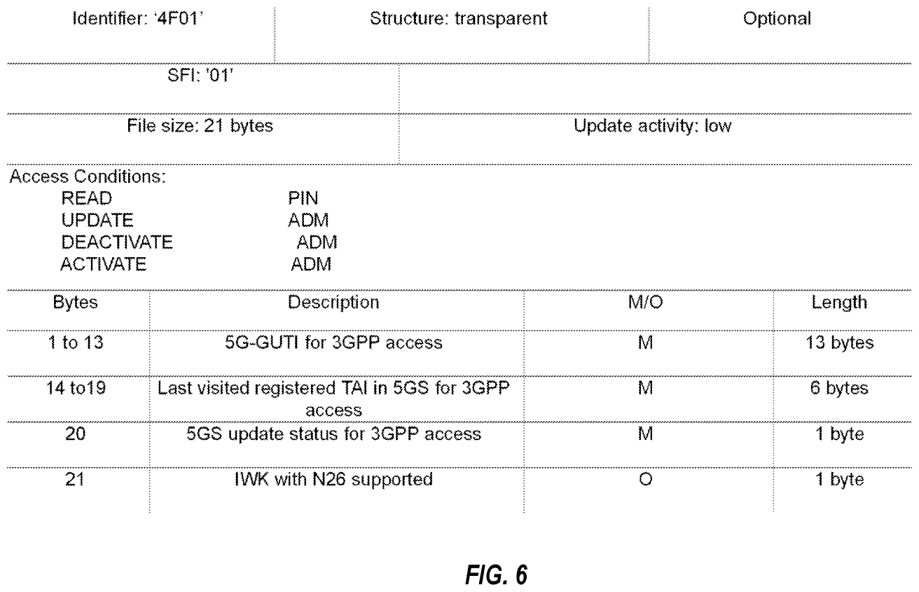

In Step 520, the received indicator is stored. In embodiments disclosed herein, the indicator may be stored in NVM of the ME and/or in the USIM of the UE. More specifically, the indicator may be stored with 5GMM parameters in a non-volatile memory in the ME together with the SUPI from the USIM. On the USIM, the indicator may be stored in the Elementary File (EF) that includes 5GS location information for 3GPP access, such as the 5G-Globally Unique Temporary Identifier (5G-GUTI), last visited registered Tracking Area Identity in 5GS (TAI), 5GS update status, etc. (see, e.g., FIG. 6).

In Step 530, the connection to the first network is lost. The connection may be lost due to a power loss of the device, loss of radio connection to the device, or other scenarios.

While the connection is lost, the device may move, or network conditions may change, such that device is unable to reconnect to the first network. Therefore, in Step 540, a connection to a second network is established using the stored N26 indicator. The connection may be established according to standards for Establishment of the NAS signalling connection, Attach Procedure Initiation, and E-UTRAN Initial Attach. In embodiments disclosed herein, by storing the N26 indicator, the device is capable of using an appropriate GUTI and device identity to facilitate the connection to the second network using such standards.

More specifically, in establishment of the NAS signalling connection, if the UE has received the interworking without N26 interface indicator set to “interworking without N26 interface not supported” from the network, the UE holds a valid 5G-GUTI and the UE which was previously registered in NI mode before entering state 5GMM-DEREGISTERED, performs an initial EPS attach procedure.

In the Attach Procedure Initiation, if the UE operating in the single-registration mode is performing an inter-system change from N1 mode to S1 mode or the UE was previously registered in N1 mode before entering state 5GMM-DEREGISTERED and 1) the UE has received the interworking without N26 interface indicator set to “interworking without N26 interface supported” from the network and: i) if the UE holds a valid GUTI, the UE shall include the valid GUTI into the EPS mobile identity IE, include Old GUTI type IE with GUTI type set to “native GUTI” and include the UE status IE with a 5GMM registration status set to: “UE is in 5GMM-REGISTERED state” if the UE is in 5GMM-REGISTERED state; or “UE is in 5GMM-DEREGISTERED state” if the UE is in 5GMM-DEREGISTERED state; or ii) if the UE does not hold a valid GUTI, the UE shall include the IMSI in the EPS mobile identity IE; or 2) the UE has received the interworking without N26 interface indicator set to “interworking without N26 interface not supported” from the network and: i) if the UE holds a valid native 5G-GUTI, the UE shall include a GUTI, mapped from the 5G-GUTI into the EPS mobile identity IE, include Old GUTI type IE with GUTI type set to “native GUTI” and include the UE status IE with a 5GMM registration status set to “UE is in 5GMM-DEREGISTERED state”; ii) if the UE holds a valid GUTI and does not hold a valid 5G-GUTI, the UE shall indicate the GUTI in the EPS mobile identity IE and include Old GUTI type IE with GUTI type set to “native GUTI”; or iii) if the UE holds neither a valid GUTI nor a valid 5G-GUTI, the UE shall include the IMSI in the EPS mobile identity IE.

In the E-UTRAN Initial Attach, if the UE was previously registered in 5GS, the UE provides in Access Stratum signalling a GUMMEI mapped from the 5G-GUTI and indicates it as a native GUMMEI and should in addition indicate it as “Mapped from 5G-GUTI”. If the UE was previously registered in 5GS, the UE provides, in the Attach Request message, an EPS GUTI mapped from 5G-GUTI sent as old Native GUTI and indicates that it is moving from 5GC. The UE integrity protects the Attach Request message using the 5G security context.

Because interworking 5GS with EPS using N26 is the main deployment scenario for most operators, embodiments disclosed herein will use the appropriate identity of the device and will be able to obtain service after inter system change from 5GS to EPS and vice versa.

FIG. 6 is an example of storing the N26 indicator in a USIM, according to some aspects. FIG. 6 illustrates an EF associated with 5GS 3GPP location information. If the service (e.g., n°122) is available, a file similar to FIG. 6 is present. The EF may contain 5GS location information for 3GPP access such as 5G-Globally Unique Temporary Identifier (5G-GUTI), last visited registered Tracking Area Identity in 5GS (TAI), 5GS update status, and the IWK without N26 interface indicator. The IWK without N26 interface indicator indicates whether interworking without N26 interface is supported. The indicator may be coded by “0” when the interworking without N26 interface not supported, and “1” when the interworking without N26 interface is supported.

Embodiments disclosed herein also include storing the signal level of available cells so that the signal levels may be taken into account during some initial steps of network selection. As part of SENSE development, embodiments include a UE with stored thresholds to be used as access thresholds for particular tracking areas, etc.

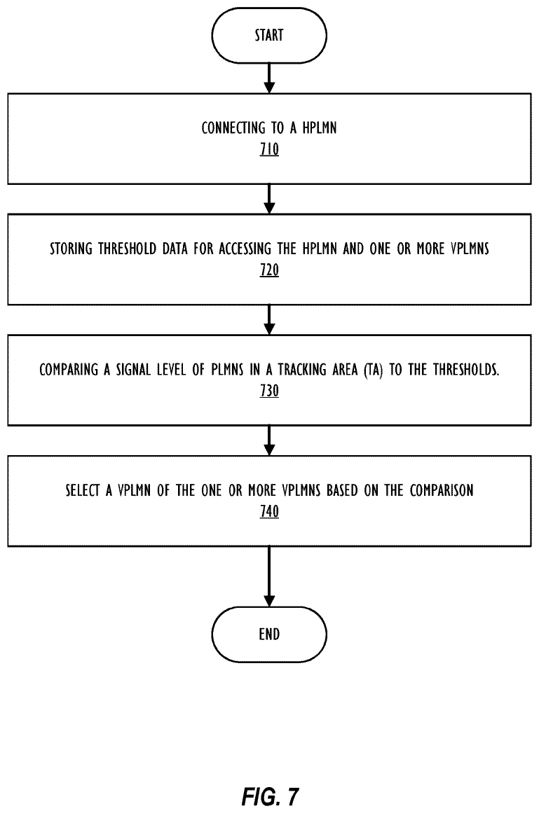

FIG. 7 demonstrates a method for PLMN selection using the stored thresholds, according to some aspects. In Step 710, a UE connects to a Home-PLMN. In these embodiments, the UE may be a stationary IoT device. In some embodiments, an initial connection to the HPLMN may be omitted, provided the threshold information discussed herein is available in the UE device.

The UE stores thresholds for accessing the HPLMN and one or more VPLMNs in Step 720. The thresholds may be obtained via the HPLM. The thresholds may be provisioned as part of SOR in accordance with embodiments herein. In embodiments, as part of the 5GMM parameters stored in a non-volatile memory in the ME together with the SUPI from the USIM, an “Operator controlled signal threshold per access technology” that includes the thresholds may be stored. The “Operator controlled signal threshold per access technology” may be stored if the UE supports SENSE.

In some embodiments, the “Operator controlled signal threshold per access technology” may only be used if the SUPI from the USIM matches the SUPI stored in the non-volatile memory of the ME. If there is no match, the UE may delete the “Operator controlled signal threshold per access technology” stored in the UE.

In Step 730, a signal level of PLMNs in a Tracking Area (TA) are compared to the stored thresholds. This comparison may be triggered based on the initial steps of network/PLMN selection, switching on the power, recovery from power loss, recover from loss of coverage, and during steps of a periodic re-selection.

In Step 740, a VPLMN of the one or more VPLMNs may be selected based on the comparison to the threshold. By selecting a VPLMN based on the stored thresholds, a stationary IoT UE that finds itself in a roaming situation with low HPLMN signal may move to a more desirable VPLMN without user intervention. That is, if the HPLMN is available but signal strength is below a threshold, the stationary IoT device can take the liberty of exploring VPLMNs that may offer the services with better radio conditions/signal strength.

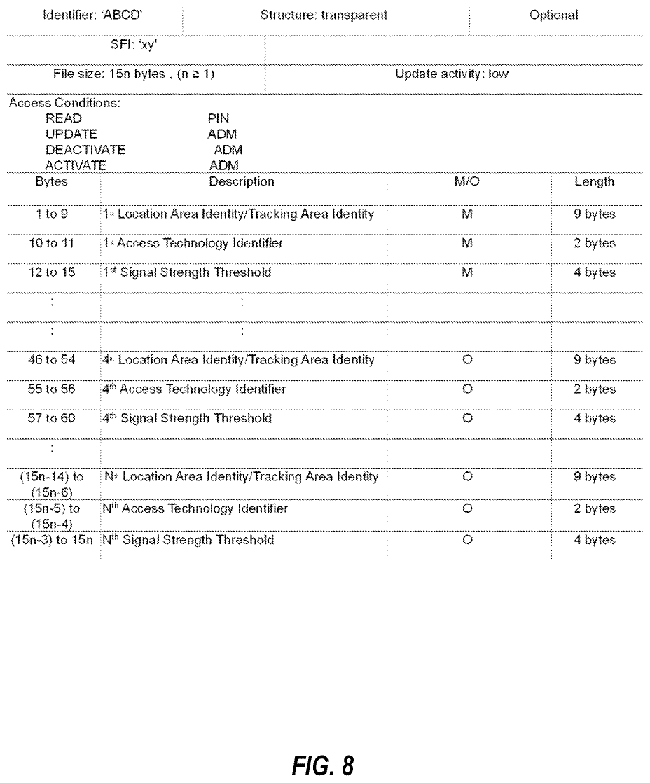

FIG. 8 illustrates storing the thresholds in an EF of a USIM, according to some aspects. Embodiments may store the thresholds with the TAI and the Access technology identifier. The TAI includes the Mobile Country Code (MCC), Mobile Network Code (MNC), and Tracking Area Code (TAC). The threshold may be stored as a signal strength threshold represented by an integer using four bytes.

As shown in FIG. 8, the EF may be an EF associated with operator controlled signal threshold per access technology. As per standard USIM technologies, if the service (e.g., n°145) is available, a file similar to FIG. 8 is present. The EF contains the coding for Location Area Code (LAC)/TAC, access technologies, and the associated operator controlled signal threshold for the access technology.

Embodiments are directed to storing information in a UE to facilitate the operation of the UE. Embodiments have the advantage of a more efficient reconnection process when utilizing an N26 interface because of the stored indicator, and the ability to select an alternative VPLMN in certain conditions based on stored thresholds.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102, Network 100) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1. A method for inter-system mobility, the method comprising:
receiving an N26 indicator when connecting to a first network;
storing the N26 indicator;
losing the connection to the first network after storing the N26 indicator; and
connecting to a second network using the N26 indicator.

2. The method of claim 1, wherein the N26 indicator is a single bit indicator that indicates whether interworking without an N26 interface is supported.

3. The method of claim 1, wherein the N26 indicator is stored in non-volatile memory.

4. The method of claim 1, wherein the N26 indicator is stored in a Universal Subscriber Identity Module (USIM).

5. The method of claim 1, wherein the first network is a 5G system (5GS) or an Evolved Packet System (EPS).

6. The method of claim 1, wherein the second network is a 5G system (5GS) or an Evolved Packet System (EPS).

7. The method of claim 1, wherein losing the connection to the first network comprises at least one of the following: turning off power, recovery from a power loss, and recovery from a loss of coverage.

8.-17. (canceled)

18. A wireless device comprising:
a receiver;
a transmitter;
at least one interface; and
a processor configured to cause the wireless device to:
receive an N26 indicator when connecting to a first network;
store the N26 indicator;
detect a loss of the connection to the first network after storing the N26 indicator; and
connect to a second network using the N26 indicator.

19. The wireless device of claim 18, wherein the N26 indicator is a single bit indicator that indicates whether interworking without an N26 interface is supported.

20. The wireless device of claim 18, wherein the N26 indicator is stored in non-volatile memory.

21. The wireless device of claim 18, wherein the N26 indicator is stored in a Universal Subscriber Identity Module (USIM).

22. The wireless device of claim 18, wherein the first network is a 5G system (5GS) or an Evolved Packet System (EPS).

23. The wireless device of claim 18, wherein the second network is a 5G system (5GS) or an Evolved Packet System (EPS).

24. The wireless device of claim 18, wherein losing the connection to the first network comprises at least one of the following: turning off power, recovery from a power loss, and recovery from a loss of coverage.

25. A baseband processor configured to cause a wireless device to:
receive an N26 indicator when connecting to a first network;
store the N26 indicator;
detect a loss of the connection to the first network after storing the N26 indicator; and
connect to a second network using the N26 indicator.

26. The baseband processor of claim 25, wherein the N26 indicator is a single bit indicator that indicates whether interworking without an N26 interface is supported.

27. The baseband processor of claim 25, wherein the N26 indicator is stored in non-volatile memory.

28. The baseband processor of claim 25, wherein the N26 indicator is stored in a Universal Subscriber Identity Module (USIM).

29. The baseband processor of claim 25, wherein the first network is a 5G system (5GS) or an Evolved Packet System (EPS).

30. The baseband processor of claim 25, wherein the second network is a 5G system (5GS) or an Evolved Packet System (EPS).
